(19) United States
(12) Patent Application Publication
(10) Pub. No.: US 2026/0016066 A1
(43) Pub. Date: Jan. 15, 2026

(54) TUBULAR VIBRATION-DAMPING DEVICE FOR MOTOR MOUNT

(71) Applicant: Sumitomo Riko Company Limited, Komaki-shi (JP)

(72) Inventor: Hirotaka MATSUI, Komaki-shi (JP)

(73) Assignee: Sumitomo Riko Company Limited, Komaki-shi (JP)

(21) Appl. No.: 19/335,750

(22) Filed: Sep. 22, 2025

Related U.S. Application Data
(63) Continuation of application No. PCT/JP2024/025841, filed on Jul. 18, 2024.

(30) Foreign Application Priority Data
Jul. 24, 2023 (JP) 2023-120034

(51) Int. Cl. F16F 1/38

(52) U.S. Cl. CPC F16F 1/3828

(57) ABSTRACT

A tubular vibration-damping device for a motor mount including an inner shaft member, an outer tube member, and two rubber legs extending between opposed faces of the inner shaft member and the outer tube member while connecting them. Both the rubber legs are arranged on a lower side of the inner shaft member that is a compression side during input of a principal load, and extend vertically at positions that are remote from each other in a left-right direction. Each rubber leg includes a connecting rubber part that is vertically continuous and directly connects the opposed faces of the inner shaft member and the outer tube member. Each rubber leg includes a rubber projection protruding in an axial direction. The rubber projection is arranged to be located on a left-right inside of a left-right outer edge of the connecting rubber part.

### INCORPORATED BY REFERENCE

This application is a Continuation of International Application No. PCT/JP2024/025841 filed on Jul. 18, 2024, which claims priority under 35 U.S.C. §§ 119(a) and 365 of Japanese Patent Application No. 2023-120034 filed on Jul. 24, 2023, the disclosures of which are expressly incorporated herein by reference in their entireties.

### BACKGROUND ART

### 1. Technical Field

The present disclosure relates to a tubular vibration-damping device for a motor mount used as a motor mount for connecting an electric motor to a vehicle body in a vibration-damping manner, in an electrification vehicle such as an electric vehicle (BEV) and a hybrid car.

### 2. Description of the Related Art

With the recent shift to electrification of vehicles, development of a motor mount that connects an electric motor to a vehicle body in a vibration-damping manner has been promoted. For example, a tubular vibration-damping device wherein an inner shaft member and an outer tube member are interconnected by rubber legs extending in the radial direction is used as the motor mount. As a tubular vibration-damping device for a motor mount, a four-leg structure with two rubber legs each on the upper and lower sides of the inner shaft member is adopted. Meanwhile, for example, as disclosed in U.S. Publication No. US 2008/0258364 A1, a structure in which two elastic legs (rubber legs) are provided below an inner cylinder (an inner shaft member) is also being considered for application to a motor mount.

### SUMMARY

By the way, in a motor mount that supports an electric motor which has lower vibration than an internal combustion engine in a vibration-damping manner in particular, deterioration of vibration state in a high-frequency range caused by surging of the rubber legs is likely to become a problem. Therefore, it is disclosed in US 2008/0258364 A1 that a mass projection projecting in the axial direction is provided to the elastic leg, and that the surging of the elastic leg is suppressed by resonance of the mass projection.

However, in the tubular vibration-damping device of US 2008/0258364 A1, the bonded surfaces of the elastic leg to the inner tube and to the outer tube (the outer tube member) are remote from each other as viewed in the vertical direction, which is the main vibration input direction. Accordingly, the elastic legs undergo shear deformation over a wide area during vibration input, which may limit a degree of freedom in tuning spring characteristics of the elastic legs, or the like. Besides, in addition to the fact that the amount of deformation of the elastic legs is likely to increase due to the dominance of shear deformation, strain is likely to be concentrated around the mass projection when the elastic leg undergoes deformation. Thus, if one wishes to reliably obtain durability, the formation position of the mass projection is greatly limited, as specified in US 2008/0258364 A1.

It is therefore one object of the present disclosure to provide a tubular vibration-damping device for a motor mount of novel structure which is able to suppress deterioration of vibration damping performance due to surging of the rubber legs, while reliably obtaining durability and furthermore obtaining a large degree of freedom in characteristic tuning.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a tubular vibration-damping device for a motor mount comprising: an inner shaft member; an outer tube member; and two rubber legs extending between opposed faces of the inner shaft member and the outer tube member while connecting the inner shaft member and the outer tube member, wherein the two rubber legs are both arranged on a lower side of the inner shaft member that is a compression side during input of a principal load, and extend in a vertical direction at positions that are remote from each other in a left-right direction, each of the two rubber legs includes a connecting rubber part that is continuous in the vertical direction and directly connects the opposed faces of the inner shaft member and the outer tube member, each of the two rubber legs includes a rubber projection protruding in an axial direction, and the rubber projection is arranged such that the rubber projection is located on a left-right inside of a left-right outer edge of the connecting rubber part.

According to the tubular vibration-damping device for the motor mount structured following the present preferred embodiment, the two rubber legs are located only on the lower side of the inner shaft member. This makes it easier to reliably obtain the free length and the volume of the two rubber legs compared to the case where the rubber legs are located on both the upper and lower sides of the inner shaft member, thereby achieving improvement in durability, for example. Besides, each of the two rubber legs includes the connecting rubber part that is continuous in the vertical direction and directly connects the opposed faces of the inner shaft member and the outer tube member, and a compression spring component is advantageously ensured when the principal load is input. This makes it possible to set spring characteristics with a greater degree of freedom in tuning, as well as to achieve further improvement in durability or the like due to the amount of deformation of the connecting rubber part being suppressed.

By providing the rubber projection on each rubber leg, mass damper action of the rubber projection or the like makes it possible to prevent deterioration of the vibration state due to bending resonance (surging) of the rubber leg. Since each rubber projection protrudes in the axial direction, when the rubber leg is deformed during vibration input, for example, the rubber projection is less likely to interfere with other components such as the outer tube member.

Additionally, the connecting rubber part is the compression region of the rubber leg arranged below the inner shaft member (the region where the compression load is directly or dominantly exerted during input of vertical load by directly connecting the vertically opposed faces of the inner shaft member and the outer tube member), and the rubber projection is arranged in the connecting rubber part such that the rubber projection is located on the left-right inside of the left-right outer edge of the connecting rubber part. Therefore, compared to the case where the rubber projection is provided in the shear deformation region on the left-right outside of the left-right outer edge of the connecting rubber part (the region where the shear deformation increases during input of vertical load because the vertically opposed faces of the inner shaft member and the outer tube member are not directly connected), when the rubber leg is elastically deformed due to vibration input, strain around the rubber projection is reduced, thereby improving durability.

A second preferred embodiment provides the tubular vibration-damping device for the motor mount according to the first preferred embodiment, wherein at least 90% of the rubber projection is located on the connecting rubber part so that the rubber projection is provided substantially only on the connecting rubber part.

According to the tubular vibration-damping device for the motor mount structured following the present preferred embodiment, the rubber projection is provided substantially only on the connecting rubber part, which is the compression region of the rubber leg. Thus, the strain around the rubber projections is more effectively reduced when the rubber leg is deformed.

A third preferred embodiment provides the tubular vibration-damping device for the motor mount according to the first or second preferred embodiment, wherein the inner shaft member includes a pair of rubber bonded parts protruding to left and right sides, the two rubber legs are bonded to the respective ones of the pair of rubber bonded parts, and a stopper protrusion is provided between the pair of rubber bonded parts of the inner shaft member, the stopper protrusion protruding downward between the two rubber legs.

According to the tubular vibration-damping device for the motor mount structured following the present preferred embodiment, the inner shaft member includes the pair of rubber bonded parts protruding to the left and right sides. This makes it easier to arrange the two rubber legs on the lower side of the inner shaft member, and to sufficiently ensure the cross-sectional area of the connecting rubber part, thereby largely obtaining the compression spring component.

Besides, the two rubber legs are bonded to the respective ones of the pair of rubber bonded parts that protrude to the left and right sides. Accordingly, a space is reliably obtained between the two rubber legs in the left-right direction, and the stopper protrusion protruding downward is provided to the inner shaft member utilizing the said space. This makes it possible to constitute a stopper mechanism for limiting the amount of relative displacement between the inner shaft member and the outer tube member in the vertical direction by contact between the stopper protrusion and the outer tube member side.

A fourth preferred embodiment provides the tubular vibration-damping device for the motor mount according to any one of the first through third preferred embodiments, wherein a stopper rubber is provided between the two rubber legs, the stopper rubber protruding in the vertical direction between the inner shaft member and the outer tube member.

According to the tubular vibration-damping device for the motor mount structured following the present preferred embodiment, it is possible to provide a stopper mechanism for limiting the amount of downward displacement of the inner shaft member relative to the outer tube member by indirect contact between the inner shaft member and the outer tube member via the stopper rubber utilizing the space between the two rubber legs.

A fifth preferred embodiment provides the tubular vibration-damping device for the motor mount according to any one of the first through fourth preferred embodiments, wherein a width dimension of the connecting rubber part is at least 20% of a width dimension of the corresponding rubber leg so that a compression spring component is larger than a shear spring component in the rubber leg with respect to downward input.

According to the tubular vibration-damping device for the motor mount structured following the present preferred embodiment, the compression spring component is dominant in the rubber leg provided with the rubber projection. Thus, the strain around the rubber projection is reduced compared to the case where the rubber projection is provided in the rubber leg where the shear spring component is dominant.

Additionally, the width dimension of the connecting rubber part is set in a sufficiently large proportion to the width dimension of the rubber leg. This makes it possible to set the arrangement of the rubber projection on the axial end face of the rubber leg with a large degree of freedom.

According to the present disclosure, in the tubular vibration-damping device for the motor mount, it is possible to suppress the deterioration of vibration damping performance due to surging of the rubber legs, while reliably obtaining durability and furthermore obtaining a large degree of freedom in characteristic tuning.

### BRIEF DESCRIPTION OF THE DRAWINGS

The foregoing and/or other objects, features and advantages of the disclosure will become more apparent from the following description of a practical embodiment with reference to the accompanying drawings in which like reference numerals designate like elements and wherein:

FIG. 1 is a perspective view of a motor mount according to a first practical embodiment of the present disclosure;

FIG. 2 is a front view of the motor mount shown in FIG. 1;

FIG. 3 is a cross sectional view taken along line 3-3 of FIG. 2; and

FIG. 4 is a graph showing spring characteristics of the motor mount shown in FIG. 1.

### DETAILED DESCRIPTION

Hereinafter, a practical embodiment of the present disclosure will be described with reference to the drawings.

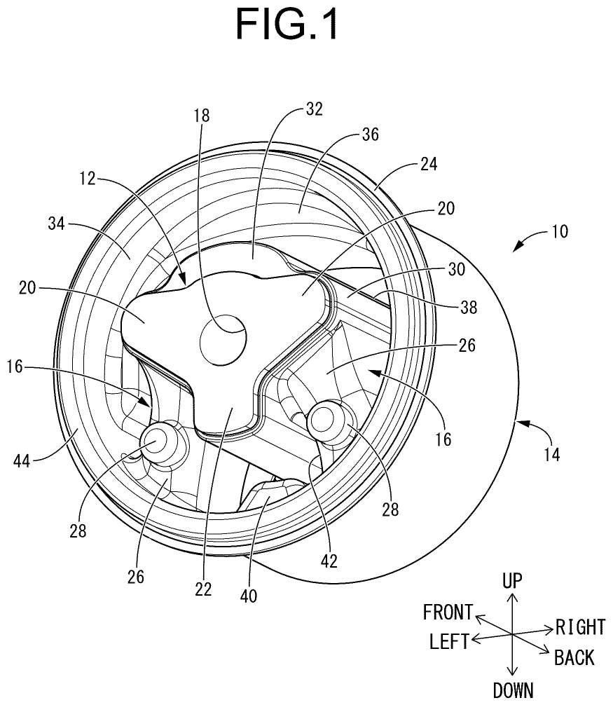

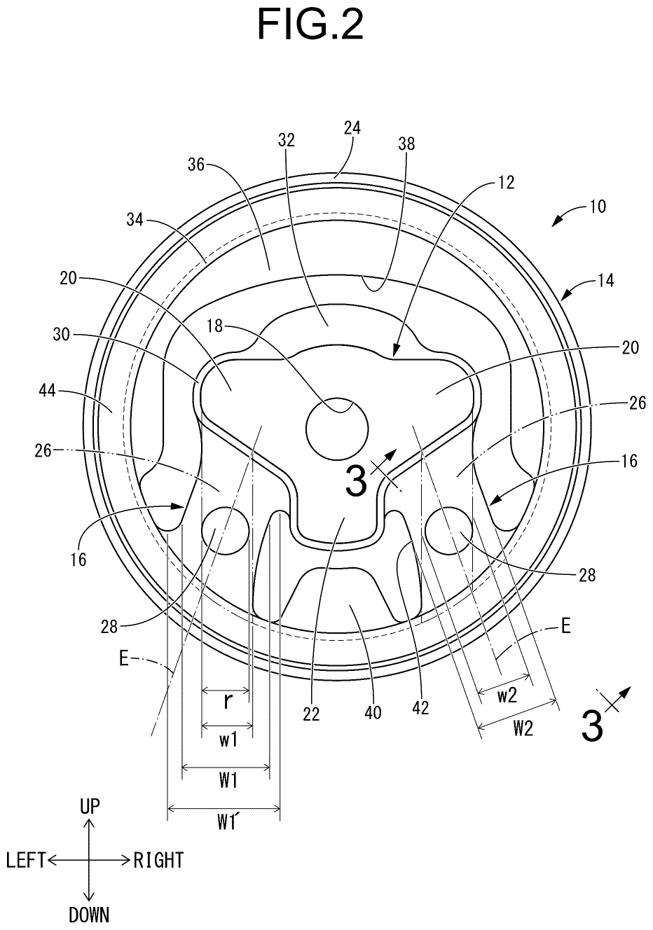

FIGS. 1 and 2 show a motor mount 10 for a vehicle as a first practical embodiment of a tubular vibration-damping device for a motor mount according to the present disclosure. The motor mount 10 has a structure in which an inner shaft member 12 and an outer tube member 14 are interconnected by two rubber legs 16, 16. In the following description, as a general rule, the vertical direction refers to the vertical direction in FIG. 2, the left-right direction refers to the left-right direction in FIG. 2 and the front-back direction refers to the direction orthogonal to the paper surface in FIG. 2, which is the axial direction. The vertical direction in the following description is the direction of principal load input to the motor mount 10, and does not necessarily match with the vertical direction of the vehicle in a mounted state onto the vehicle described later. Similarly, the left-right direction and the front-back direction in the following description do not necessarily match with the left-right direction and the front-back direction of the vehicle, respectively.

The inner shaft member 12 is a high rigidity component formed of, for example, a metal such as iron or aluminum alloy, a fiber-reinforced synthetic resin, or the like. The inner shaft member 12 has a pillar shape overall, and can be easily manufactured by, for example, extrusion process, since it has an approximately constant cross-sectional shape and extends in a straight line. An attachment hole 18 is formed so as to pass through the central portion of the inner shaft member 12 in the axial direction.

The inner shaft member 12 of the practical embodiment includes rubber bonded parts 20, 20 protruding to the left and right sides. Each rubber bonded part 20 has an upper surface that spreads approximately orthogonally to the vertical direction and a lower surface that slopes upward outwardly to the left and right, so as to become narrower in the vertical direction towards its protruding distal end. The protruding distal end face of the rubber bonded part 20 has a curved shape when viewed in the axial direction, and is smoothly continuous with both the upper and lower surfaces. The rubber bonded parts 20, 20 on the left and right sides have a symmetrical shape with respect to a plane that is orthogonal to the left-right direction. The rubber bonded part 20 of the present practical embodiment is provided continuously across the entire axial length of the inner shaft member 12, but may, for example, be shorter in axial length than other parts of the inner shaft member 12.

The inner shaft member 12 includes a stopper protrusion 22 protruding downward. The stopper protrusion 22 protrudes downward with an approximately constant left-right width dimension at the left-right central portion of the inner shaft member 12. The protruding distal end face of the stopper protrusion 22 may be a plane or the like, but in the present practical embodiment, it has a curved shape that is convex downward when viewed in the axial direction. The stopper protrusion 22 of the practical embodiment is provided continuously across the entire axial length of the inner shaft member 12, but may, for example, be shorter in axial length than other parts of the inner shaft member 12.

The outer tube member 14 has a thin-walled, large-diameter, generally round tubular shape, and a flanged part 24 protruding radially outward is integrally formed with one axial end. The flanged part 24 of the outer tube member 14 can be omitted, for example, in the case where a stopper mechanism using a front cushioning rubber 44 described later is expendable, or the like.

The inner shaft member 12 is inserted into the radial inside of the outer tube member 14, and the two rubber legs 16, 16 are provided between those inner shaft member 12 and outer tube member 14. The two rubber legs 16, 16 extend in an approximately vertical direction between the radially opposed faces of the inner shaft member 12 and the outer tube member 14. The upper end faces of the rubber legs 16, 16 are bonded by vulcanization to the respective lower surfaces of the rubber bonded parts 20, 20 of the inner shaft member 12, while the lower end faces thereof are bonded by vulcanization to the inner circumferential surface of the outer tube member 14. In the present practical embodiment, the rubber legs 16 are bonded by vulcanization not only to the lower surfaces of the rubber bonded parts 20 but also to the upper left-and-right side surfaces of the stopper protrusion 22.

The two rubber legs 16, 16 are both arranged on the lower side of the inner shaft member 12 and are compressed when the inner shaft member 12 is displaced downward relative to the outer tube member 14 by input of the principal load in the mounted state onto the vehicle described later. Besides, the two rubber legs 16, 16 are arranged to be remote from each other in the left-right direction, and extend in the vertical direction at the positions that are remote from each other in the left-right direction. The stopper protrusion 22 of the inner shaft member 12 protrudes between the two rubber legs 16, 16. The upper ends of the two rubber legs 16, 16 are located above the vertical center of the outer tube member 14, so as to have a large free length.

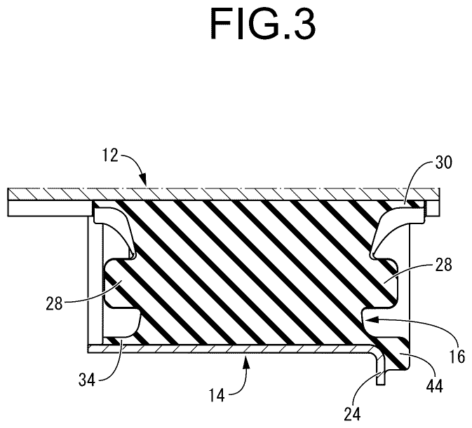

The rubber leg 16 has an elastic principal axis E in the vertical extension direction, shown by the dot-and-dash line in FIG. 2. The elastic principal axis E slopes outwardly to the left and right toward the bottom, so that the two rubber legs 16, 16 form an inverted V-letter configuration when viewed in the axial direction. Particularly in the present practical embodiment, in both the left-right inner face and the left-right outer face of each rubber leg 16, the end on the outer tube member 14 side is more outwardly located in the left-right direction with respect to the mount center line extending in the vertical direction than the end on the inner shaft member 12 side. As shown in FIGS. 1 and 3, the rubber leg 16 has an axial width dimension smaller than those of the inner shaft member 12 and the outer tube member 14, and is provided in the axially middle portion of the inner shaft member 12 and the outer tube member 14.

Each rubber leg 16 includes a connecting rubber part 26 directly connecting opposed faces of the inner shaft member 12 and the outer tube member 14. The connecting rubber part 26 is located between the vertically opposed faces of the rubber bonded part 20 of the inner shaft member 12 and the outer tube member 14, and is continuous between the rubber bonded part 20 of the inner shaft member 12 and the outer tube member 14 in the vertical direction.

The left-right width dimension w1 of the connecting rubber part 26 is preferably at least 20%, and more preferably at least 40%, of the left-right width dimension W1 of the rubber leg 16. Moreover, the left-right width dimension w1 of the connecting rubber part 26 is preferably at least 25% of the left-right width dimension W1′ of the middle portion of the rubber leg 16. Furthermore, the width dimension w2 of the connecting rubber part 26 in the direction orthogonal to the elastic principal axis E of the rubber leg 16 is preferably at least 20%, and more preferably at least 40%, of the width dimension W2 of the rubber leg 16 in the same direction. In this way, by ensuring a sufficiently large proportion of the connecting rubber part 26 in the rubber leg 16, the rubber leg 16 is designed such that the compression spring component is larger than the shear spring component during input of a downward principal load by which the inner shaft member 12 is displaced downwardly relative to the outer tube member 14. The connecting rubber part 26 is illustrated by being enclosed by the chain double-dashed line in FIG. 2. Besides, the left-right width dimension W1 of the rubber leg 16 refers to the left-right width dimension of the portion that is off the fillet surface (the fillet radius) at the ends of the rubber leg 16 bonded to the inner shaft member 12 and the outer tube member 14.

As shown in FIGS. 1 to 3, each rubber leg 16 integrally includes a rubber projection 28 protruding in the axial direction. The rubber projection 28 has an approximately cylindrical shape, and protrudes from the central portion of the axial end face of the rubber leg 16. The rubber projection 28 is arranged on the elastic principal axis E extending in the direction of extension of the rubber leg 16.

The rubber projection 28 is arranged in a position that is located inside the left-right outer edge of the connecting rubber part 26 of the rubber leg 16 in the left-right direction. That is, the left-right outer edge of the rubber projection 28 does not protrude left-right outward from the left-right outer edge of the connecting rubber part 26, but is located at the same position or inward in the left-right direction. It is desirable that at least 60% of the axial projected area of the rubber projection 28 be located on the connecting rubber part 26. More preferably, at least 90% of the axial projected area of the rubber projection 28 is located on the connecting rubber part 26 so that the rubber projection 28 is provided substantially only on the connecting rubber part 26. In the present practical embodiment, the rubber projection 28 is located between the left and right edges of the connecting rubber part 26, and is located on the connecting rubber part 26 in its entirety. In the present practical embodiment, the left-right width dimension (the diameter r) of the rubber projection 28 is approximately the same as or slightly smaller than the left-right width dimension w1 of the connecting rubber part 26. As shown in FIG. 3, the rubber projection 28 protrudes on each side of the rubber leg 16 in the axial direction.

As shown in FIGS. 1 to 3, the outer circumferential surface of the inner shaft member 12 is covered by an inner rubber layer 30 integrally formed with the rubber legs 16, 16. Regarding the inner rubber layer 30, the portion covering the lower surface and the left-and-right side surfaces of the inner shaft member 12 has an approximately constant thickness dimension, while the portion covering the upper surface of the inner shaft member 12 comprises a thick-walled inside cushioning rubber 32. However, the inner rubber layer 30 may have an approximately constant thickness dimension in its entirety, or may vary in thickness in several locations. The inner rubber layer 30 is shorter in axial length than the inner shaft member 12, and the opposite ends of the inner shaft member 12 protrude axially outward from the inner rubber layer 30 and are exposed to the outside.

The inner circumferential surface of the outer tube member 14 is covered by an outer rubber layer 34 integrally formed with the rubber legs 16, 16. The outer rubber layer 34 includes an upper cushioning rubber 36 protruding radially inward. The upper cushioning rubber 36 is provided above and on the left-and-right opposite sides of the inner shaft member 12, and is provided continuously in the circumferential direction for not less than half the circumference of the upper part of the outer tube member 14. The upper cushioning rubber 36 is remote from the inner shaft member 12 to the upper side and to the left-and-right opposite sides, and its circumferentially opposite ends are remote from the two rubber legs 16, 16 in the circumferential direction. Accordingly, a first bored hole 38 penetrating in the axial direction is formed between the upper cushioning rubber 36 on one side and the inner shaft member 12 (the inner rubber layer 30) and the two rubber legs 16, 16 on the other side. When the inner shaft member 12 is greatly displaced relative to the outer tube member 14 upward or to the left or right side, the inner shaft member 12 and the outer tube member 14 come into contact with each other via the upper cushioning rubber 36, thereby forming a stopper mechanism that limits the amount of displacement of the inner shaft member 12 upward or to the left or right side relative to the outer tube member 14.

Besides, the outer rubber layer 34 includes a lower cushioning rubber 40 serving as a stopper rubber. The lower cushioning rubber 40 is provided below the stopper protrusion 22 of the inner shaft member 12, and protrudes upward from the outer tube member 14 towards the inner shaft member 12. The lower cushioning rubber 40 has a tapered shape that contracts in the front-back direction and in the left-right direction toward the protruding distal end. The lower cushioning rubber 40 is located between the two rubber legs 16, 16 in the left-right direction, and is remote from the stopper protrusion 22 of the inner shaft member 12 downward by a predetermined stopper clearance. Accordingly, a second bored hole 42 penetrating in the axial direction is formed between the lower cushioning rubber 40 on one side and the inner shaft member 12 (the inner rubber layer 30) and the two rubber legs 16, 16 on the other side. When the inner shaft member 12 is greatly displaced relative to the outer tube member 14 downward, the inner shaft member 12 and the outer tube member 14 come into contact with each other via the lower cushioning rubber 40, thereby forming a stopper mechanism that limits the amount of displacement of the inner shaft member 12 downward relative to the outer tube member 14.

The stopper rubber may, for example, be integrally formed with the inner rubber layer 30 so as to protrude downward from the protruding distal end face of the stopper protrusion 22 of the inner shaft member 12. In this case, the stopper rubber is arranged so as to be remote upward from the inner circumferential surface of the outer tube member 14 (the outer rubber layer 34). Besides, the stopper rubber in this case preferably has a shape tapering downward.

The outer rubber layer 34 includes a front cushioning rubber 44 bonded to the flanged part 24. The front cushioning rubber 44 is formed continuously about the entire circumference while being bonded to the front surface of the flanged part 24, which is the axially outer surface thereof, and protrudes forward from the flanged part 24. The radially inner end of the front cushioning rubber 44 protrudes radially inward with respect to the outer tube member 14, and is integrally continuous with the outer rubber layer 34 at the radially inner end. The outer peripheral end of the front cushioning rubber 44 is located radially inward with respect to the outer peripheral end of the flanged part 24.

The motor mount 10 of the above construction connects an electric motor (not shown) to a vehicle body (not shown) in a vibration-damping manner. Specifically, the motor mount 10 is arranged such that the inner shaft member 12 is attached to the electric motor by means of a bolt or the like inserted into the attachment hole 18, while the outer tube member 14 is attached to the vehicle body by being press-fitted into a mounting hole (not shown) provided to the vehicle body or the like. With this arrangement, the motor mount 10 is mounted on the vehicle, and the electric motor is supported in a vibration-damping manner on the vehicle body via the motor mount 10. The inner shaft member 12 may be attached directly to the electric motor, or indirectly via a bracket or the like. Similarly, the outer tube member 14 may be attached directly to the vehicle body, or indirectly via a bracket or the like. Alternatively, the inner shaft member 12 may be attached to the vehicle body side while the outer tube member 14 may be attached to the electric motor side.

With the motor mount 10 mounted on the vehicle, vibration is input across the inner shaft member 12 and the outer tube member 14, mainly in the vertical direction. When the inner shaft member 12 is displaced downwardly with respect to the outer tube member 14 by such vibration input, the two rubber legs 16, 16 arranged on the lower side of the inner shaft member 12 are compressed in the vertical direction, and the compression spring component becomes dominant over the shear spring component. In particular, the connecting rubber part 26, which is continuously provided in the vertical direction between the vertically opposed faces of the inner shaft member 12 and the outer tube member 14, is a region where the shear spring component is even smaller and undergoes substantially pure compression in response to input of the vertical compression load. When the inner shaft member 12 is displaced downwardly with respect to the outer tube member 14 by the principal load input, the two rubber legs 16, 16 function mainly as compression springs, which makes it easier to achieve high dynamic spring characteristics and makes it possible to obtain a large degree of freedom in adjusting the spring characteristics.

In the motor mount 10, the two rubber legs 16, 16 are provided only on the lower side of the inner shaft member 12, and not on the upper side of the inner shaft member 12. This enables the free length of the two rubber legs 16, 16 to be set with a large degree of freedom without increasing the diameter of the outer tube member 14, and also enables a large rubber volume to be ensured, thereby reliably obtaining freedom in setting the spring characteristics, durability, and the like of the rubber legs 16, 16.

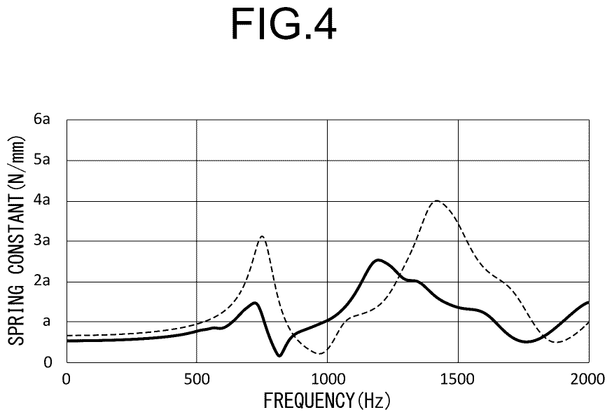

Meanwhile, when bending elastic deformation, etc. occurs in the two rubber legs 16, 16 in a resonant state during input of the vibration load, deterioration of vibration damping performance may occur due to development of high dynamic spring. In order to prevent the deterioration of vibration damping performance due to such rubber surging, the motor mount 10 includes the rubber projections 28, 28 protruding from each rubber leg 16 to the front and back sides. That is, by providing the rubber projections 28, 28 on each rubber leg 16, while suppressing influence on the spring characteristics of the rubber legs 16, 16, etc., as shown in the graph in FIG. 4, the spring peak due to resonance of the rubber legs 16, 16 is reduced by mass damper action of the rubber projections 28 or the like, thereby suppressing the deterioration of vibration damping performance due to the development of high dynamic spring. In particular, quietness of electric motors is higher than that of engines, and high-frequency vibration is more likely to be a problem in the motor mount 10 than in engine mounts. Thus, by suppressing the deterioration of vibration damping performance caused by the rubber surging of the rubber legs 16, 16 in the high-frequency range of around 1000 Hz, it is possible to provide better quietness, ride comfort, and the like. In the graph shown in FIG. 4, the spring characteristics of the motor mount 10 according to the present practical embodiment with the rubber projections 28 are indicated by the solid line, and spring characteristics of a motor mount without the rubber projections 28 are indicated by the dashed line.

Here, each rubber projection 28 is arranged so as to be located inside the left-right outer edge of the connecting rubber part 26 of the rubber leg 16 in the left-right direction. With this arrangement, the rubber projection 28 is not located in the shear deformation region on the left-right outside of the connecting rubber part 26, which undergoes shear deformation during the principal load input, but is located in the compressive deformation region of the rubber leg 16 in its entirety. As a result, strain caused by the large shear deformation of the rubber leg 16 is less likely to concentrate on the proximal end part of the rubber projection 28, thereby preventing the deterioration of durability such as occurrence of cracking at the connected portion between the rubber projection 28 and the rubber leg 16.

It is desirable that at least 60% of the rubber projection 28 be located on the connecting rubber part 26 as viewed in the axial direction. More preferably, at least 90% of the rubber projection 28 is located on the connecting rubber part 26 as viewed in the axial direction so as to be arranged on the connecting rubber part 26 substantially in its entirety. In this way, by locating approximately the entire rubber projection 28 on the connecting rubber part 26, where compressive deformation is more dominant, relief of the strain at the proximal end part of the rubber projection 28 can be achieved, thereby further improving the durability of the rubber leg 16 and the rubber projection 28. In the present practical embodiment in particular, the width dimension of the rubber projection 28 is not greater than that of the connecting rubber part 26, and the entirety of the rubber projection 28 fits between the left and right edges of the connecting rubber part 26. Thus, reduction of the strain at the proximal end part of the rubber projection 28 can be more effectively achieved.

The left-right width dimension w1 of the connecting rubber part 26 is at least 20% of the left-right width dimension W1 of the rubber leg 16. In such a way, the proportion of the connecting rubber part 26, which is the compression region, is set sufficiently large in the rubber leg 16. This makes it easier to provide the rubber projection 28 in the region where the compression spring component is larger than the shear spring component in the rubber leg 16. In particular, the left-right width dimension w1 of the connecting rubber part 26 is made large, which allows a greater degree of freedom in arrangement of the rubber projection 28 that is located on the left-right inside of the left-right outer edge of the connecting rubber part 26. Besides, it becomes easy to arrange substantially the entire rubber projection 28 on the connecting rubber part 26 while setting the size of the rubber projection 28 sufficiently large.

The motor mount 10 includes the upper and lower cushioning rubbers 36, 40 at the portions off the two rubber legs 16, 16 in the circumferential direction, and the stopper mechanisms are set to limit the amount of relative displacement between the inner shaft member 12 and the outer tube member 14 in the vertical and left-right directions. This makes it possible to prevent damage to the rubber leg 16 or the like due to excessive relative displacement between the inner shaft member 12 and the outer tube member 14 without impairing the degree of freedom of shape and arrangement of the two rubber legs 16, 16.

Moreover, the front cushioning rubber 44 is provided to the flanged part 24 provided at the axial end part of the outer tube member 14. The flanged part 24 and a component on the electric motor side come into contact with each other via the front cushioning rubber 44 to set a backward stopper mechanism that limits the amount of backward displacement of the inner shaft member 12 relative to the outer tube member 14. This makes it possible to prevent damage to the rubber leg 16 or the like due to excessive relative displacement between the inner shaft member 12 and the outer tube member 14 in the axial direction as well.

A practical embodiment of the present disclosure has been described in detail above, but the present disclosure is not limited to those specific descriptions. For example, it is acceptable as long as at least one rubber projection 28 is provided to each rubber leg 16. Specifically, for example, the rubber projection 28 may protrude from only one axial side of the rubber leg 16. Besides, the number and the positions of the rubber projections 28 provided to the two rubber legs 16, 16 can also be mutually different. However, considering the balance of the two rubber legs 16, 16 including the rubber projections 28 and the like, in preferred practice, the same number of the rubber projections 28 are provided at corresponding positions in the two rubber legs 16, 16, as shown in the preceding practical embodiment. It would also be possible to provide three or more rubber projections 28 to the rubber leg 16. In this case, two or more rubber projections 28 protrude from one axial face of the rubber leg 16.

The shape of the rubber projection 28 is not limited to a cylindrical shape, but various shapes including, for example, a polygonal pillar shape, a tubular shape, a plate shape, and the like can be adopted. Besides, the size of the rubber projection 28 such as the protrusion height and the outside diameter, is not particularly limited either.

The rubber projection 28 is not limited to the embodiment formed of rubber alone, but for example, may have a composite structure in which a mass member such as metal is provided to the rubber projection 28 or the rubber leg 16 for the purpose of tuning the mass. Besides, when tuning the characteristics of the rubber projection 28, it is acceptable as long as suppression of surging of the rubber leg 16 is achieved. For example, it would also be possible to consider dynamic damper action in addition to or instead of mass damper action, or to consider tuning action on the spring characteristics of the rubber leg 16 or the like.

In the preceding practical embodiment, the entire rubber projection 28 is located on the connecting rubber part 26, but for example, the rubber projection 28 can include a portion protruding left-right inward from the left-right inner edge of the connecting rubber part 26. The amount by which the rubber projection 28 protrudes left-right inward from the connecting rubber part 26 is not particularly limited, but is preferably set as follows, for example, in consideration of preventing concentration of the strain at the proximal end part of the rubber projection 28. Specifically, since the two rubber legs 16, 16 form an inverted V-letter configuration sloping left-right outward toward the bottom, when they are compressed in the vertical direction by the principal load input and expand in the left-right direction, the contact region between the lower end part of the rubber leg 16 and the outer tube member 14 is extended left-right inward, and the inner edge of the connecting rubber part 26 can move left-right inward. By arranging the rubber projection 28 such that the left-right inner edge of the rubber projection 28 is located on the left-right outside of the left-right inner edge position of the connecting rubber part 26 in such a compressed state of the rubber leg 16, even if the rubber projection 28 is located on the left-right inside of the connecting rubber part 26 of the rubber leg 16 to which no load is input, concentration of the strain at the proximal end part of the rubber projection 28 can be effectively prevented. In other words, regarding the pair of connecting rubber parts 26, 26, when the inner shaft member 12 moves downward relative to the outer tube member 14 due to the principal load input, such as a static distributed load, the connecting rubber parts 26, 26 are elastically deformed so as to expand in the left-right direction. Due to such elastic deformation, the left-right outer face of each connecting rubber part 26 tends to move outward off the vertically opposed faces of the inner shaft member 12 and the outer tube member 14, so as to increase the shear region. Meanwhile, the left-right inner face of each connecting rubber part 26 tends to increase the compression region that directly connects the vertically opposed faces of the inner shaft member 12 and the outer tube member 14. Therefore, even if the rubber projection 28 is located to reach the left-right inside of the connecting rubber parts 26 of the rubber legs 16, it is less likely to be a significant problem.

It is desirable that the rubber projection 28 be located on the left-right inside of the left-right outer edge of the connecting rubber part 26 in the initial state where no load is input to the rubber leg 16. However, it is acceptable as long as the rubber projection 28 is located on the connecting rubber part 26 of the rubber leg 16 in the compressed state at least. That is, with the motor mount 10 mounted on a vehicle or the like, the rubber leg 16 is in a compressed state due to input of a static distributed load (a static principal load) of the motor or the like. By so doing, the rubber projection 28 is arranged in the compression region of the rubber leg 16 in the state where the principal load is input, so that concentration of the strain around the rubber projection 28 is avoided, thereby ensuring durability. Note that the left-right outer edge of the rubber projection 28 can be located on the left-right inside of the left-right outer edge of the inner shaft member 12 as well as on the left-right outside of the left-right outer edge of the connecting rubber part 26 of the rubber leg 16 in the initial state.

For example, the inner shaft member can comprise a bonded tube part having a tubular shape and bonded to the rubber legs 16, 16, and an inner bracket inserted and fitted into the radial inside of the bonded tube part. Besides, the inner shaft member may have a cross-sectional shape that varies in the axial direction. Moreover, the inner shaft member need not include the rubber bonded parts 20, 20 or the stopper protrusion 22.

None of the stopper mechanisms for the vertical, front-back, and left-right directions are essential, and the stopper mechanism for only one or two directions may be provided, or no stopper mechanism may be provided.

What is claimed is:

1. A tubular vibration-damping device for a motor mount comprising:
an inner shaft member;
an outer tube member; and
two rubber legs extending between opposed faces of the inner shaft member and the outer tube member while connecting the inner shaft member and the outer tube member, wherein
the two rubber legs are both arranged on a lower side of the inner shaft member that is a compression side during input of a principal load, and extend in a vertical direction at positions that are remote from each other in a left-right direction,
each of the two rubber legs includes a connecting rubber part that is continuous in the vertical direction and directly connects the opposed faces of the inner shaft member and the outer tube member,
each of the two rubber legs includes a rubber projection protruding in an axial direction, and
the rubber projection is arranged such that the rubber projection is located on a left-right inside of a left-right outer edge of the connecting rubber part.

2. The tubular vibration-damping device for the motor mount according to claim 1, wherein at least 90% of the rubber projection is located on the connecting rubber part so that the rubber projection is provided substantially only on the connecting rubber part.

3. The tubular vibration-damping device for the motor mount according to claim 1, wherein
the inner shaft member includes a pair of rubber bonded parts protruding to left and right sides,
the two rubber legs are bonded to the respective ones of the pair of rubber bonded parts, and
a stopper protrusion is provided between the pair of rubber bonded parts of the inner shaft member, the stopper protrusion protruding downward between the two rubber legs.

4. The tubular vibration-damping device for the motor mount according to claim 1, wherein a stopper rubber is provided between the two rubber legs, the stopper rubber protruding in the vertical direction between the inner shaft member and the outer tube member.

5. The tubular vibration-damping device for the motor mount according to claim 1, wherein a width dimension of the connecting rubber part is at least 20% of a width dimension of the corresponding rubber leg so that a compression spring component is larger than a shear spring component in the rubber leg with respect to downward input.
